(19) United States
(12) Patent Application Publication
(10) Pub. No.: US 2009/0291036 A1
(43) Pub. Date: Nov. 26, 2009

(54) UV Sterilizer for Fluid of Large Flow Rate

(76) Inventors: Jian Chen, Fujian (CN); Minyi Han, Fujian (CN)

Correspondence Address: SALIWANCHIK LLOYD & SALIWANCHIK;A PROFESSIONAL ASSOCIATION, PO Box 142950, GAINESVILLE, FL, 32614, US

(21) Appl. No.: 12/470,171

(22) Filed: May 21, 2009

(30) Foreign Application Priority Data
May 26, 2008 (CN) 200810071135.1

(51) Int. Cl. B01J 19/08

(52) U.S. Cl. 422/186.3

(57) ABSTRACT

A UV sterilizer for fluid of large flow rate comprises at least one U V sterilization module and an mounting part for said module, each module comprising at least one UV lamp tube, said mounting part comprising a body in the form of a duct for the passage of fluid to be sterilized therethrough, with a number of mounting apertures for the UV sterilization module being provided on the wall of the duct, and on one or both end surfaces of the duct there being provided a baffle extending from the outer peripheral of said one or both end surfaces towards the center thereof, with a port being left on said one or both end surfaces with the baffle for the passage of fluid to be sterilized therethrough. The UV sterilizer for fluid of large flow rate of the present invention may be widely used in water supply plant, pharmaceutical plant, food plant, drink plant, or other plants or sites where fluid need to be sterilized.

### CROSS-REFERENCE TO A RELATED APPLICATION

This application claims priority to Chinese patent Application No. 200810071135.1, filed May 26, 2008, which is incorporated herein by reference in its entirety.

### FIELD OF THE INVENTION

The invention generally relates to ultraviolet (UV) sterilization for fluid, and more particularly to a UV sterilizer for fluid of large flow rate.

### DESCRIPTION OF RELATED ART

According to the prior art, a UV sterilizer of closed type usually has a main chamber of cylinder shape, with fluid inlets and outlets being provided on the wall of the cylinder and UV lamps being connected to the ends of the cylinder. Fluid flows into the chamber via the inlets, and flows out via the outlets after being subjected to UV radiation. Since the fluid inlets and outlets, which are respectively connected to the supply conduit and the discharge conduit, are provided on the wall of the cylinder for the inflow and outflow of the fluid, the flow pressure on said wall is increased. Moreover, it is likely to create a short circuit of fluid flow around the wall of the cylinder when a large flow rate of fluid is involved. That is, part of the fluid flow close to the cylinder wall directly flows out of the chamber without being sufficiently sterilized, which shortens the distance that fluid travels when being subjected to UV radiation thereby reducing) the amount of UV radiation applied to the fluid and impairing the sterilization effect. Further, the prior art UV sterilizer also has the disadvantage of large difference of hydraulic head between the inlets and outlets, i.e. significant loss of hydraulic head, and insufficiency of pressure resistance of the cylinder wall.

Therefore, there is a need for a UV sterilizer which is capable of avoiding short circuit of the fluid flow, and has increased pressure resistance and reduced loss of hydraulic head.

### SUMMARY OF THE INVENTION

One of the objects of this invention is to provide a UV sterilizer for fluid of large flow rate, which has a simple structure and is easy to assemble and maintain.

According to the technical solution of the present invention, a UV sterilizer for fluid of large flow rate comprises at least one UV sterilization module and a mounting part for said module, each UV sterilization module comprising at least one UV lamp tube, said mounting part comprising a body in the form of a duct for the passage of fluid to be sterilized therethrough with a number of UV sterilization module mounting apertures being provided on the wall of the duct, and on one or both end surfaces of the duct there being provided a baffle extending from the outer peripheral of said one or both end surfaces towards the center of said one or both end surfaces, with a port being left on said one or both end surfaces with the baffle for the passage of fluid to be sterilized therethrough.

Preferably, on at least one cross section between the two end surfaces of the mounting part is provided a baffle extending from the outer peripheral of the cross section towards the center thereof, with a port being left on the cross section for the passage of fluid to be sterilized therethrough. To ensure good sterilization effect, each port either on the one or both end surfaces or on the at least one cross section is within the predesigned effective radiation area of the at least one UV sterilization module.

To improve the safety of the sterilizer, the mounting part is in the form of a duct of circular cross section, so as to increase the pressure resistance thereof.

To improve the efficiency of the UV lamps, the baffle on the at least one circular cross section may be shaped as inscribing a rectangular, e.g. a square port, with the edges of said port being within the predesigned effective radiation area of the at least one UV sterilization module.

The mounting part in this technical solution may be used as a connecting part between the fluid conduits on both sides of the UV sterilizer. Likewise, all the fluid conduits in the fluid sterilization system may be connected by means of the mounting part of the UV sterilizer. In the latter case, it is possible to select some of the connecting parts for the installation of at least one UV sterilization module as required, and the mounting apertures on other connecting parts may be blocked with seals.

The UV sterilizer according to the present invention has the following advantages:

1. Since the fluid conduits may be connected by means of the mounting part(s) of the UV sterilizer(s), on the wall of which may be mounted at least one UV sterilization module, it is possible to select some of the mounting part(s) for the installation of at least one UV sterilization module as required, also it is possible to increase or decrease the number of the at least one UV sterilization module as required, thereby to effectively change the fluid flow rate capable of being processed by the sterilizer.

2. Due to the use of the baffle, the fluid is made to the maximum extent to flow through the effective UV radiation area, thus reducing the occurrence of fluid short circuit and improving the sterilization effect.

3. Due to the use of the baffle, the mounting part may be embodied in a duct with circular cross section, with fluid ports being provided on both ends of the duct, which ports can be shaped as rectangular, e.g. square, thus on one hand, improving the pressure resistance off the sterilization chamber and the safety of the fluid sterilization system, and on the other hand, improving the utilization of the UV light and reducing the cost of the system.

4. Since the fluid conduits may be connected by means of the mounting part(s) or the UV sterilizer(s), on the wall of which may be mounted at least one UV sterilization module, it is possible to select some of the mounting part(s) for the installation of at least one UV sterilization module as required, also it is possible to increase or decrease the number of the at least one UV sterilization module as required, thereby improving the sterilization effect and reducing the cost of the system.

5. Since the mounting part of the UV sterilizer is used as a connecting part between the fluid conduits on both sides of the UV sterilizer, the UV sterilizer can be mounted at the joints of the conduits, thus facilitating the installation and maintenance of the UV sterilizer.

6. It is possible to select all or some of the mounted UV sterilizers for operation, thus ensuring the sterilization effect, and enabling the sterilization system to operate normally while some of the UV sterilizers are being maintained, i.e. achieving on-line maintenance.

7. Since each mounting aperture for the at lease one UV sterilization module is blocked with a seal when no UV lamp tube is mounted therein, each mounting aperture may be individually sealed, thus achieving on-line maintenance of the sterilization system without affecting the normal operation of the system and the sterilization effect.

8. Due to the modular design of the UV sterilizer, said UV sterilizer is simple in structure and can be produced in mass, thus reducing the cost of manufacture.

### BRIEF DESCRIPTION OF THE DRAWINGS

FIG. 1 is a schematic front view of an embodiment of the UV sterilizer for fluid of large flow rate according to the present invention;

FIG. 2 is a schematic top view of the embodiment shown in FIG. 1; and

FIG. 3 is a schematic side view of the embodiment shown in FIG. 1.

### REFERENCE NUMERAL LIST

1 UV sterilization module
101 UV lamp tube
2 mounting part of the UV sterilization module 1
201 end surface of the mounting part 2
202 baffle on the end surface
203 fluid port
204 cross section of the mounting part
3 connecting means on the mounting part 2
4 mounting aperture for the UV sterilization module

### DETAILED DESCRIPTION OF PREFERRED EMBODIMENT

In the following one embodiment of the present invention will be described in detail with reference to the drawings.

In this context, the term “number” means one or an integral greater than one.

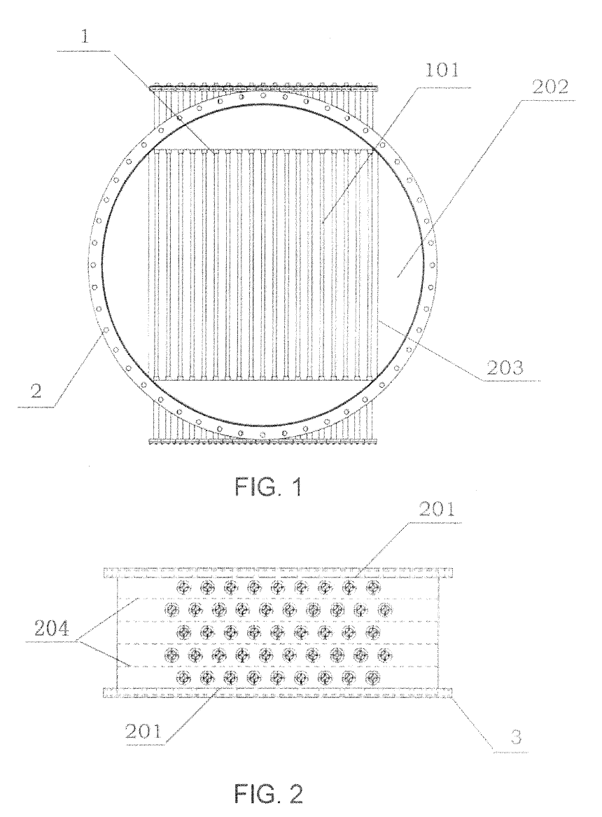

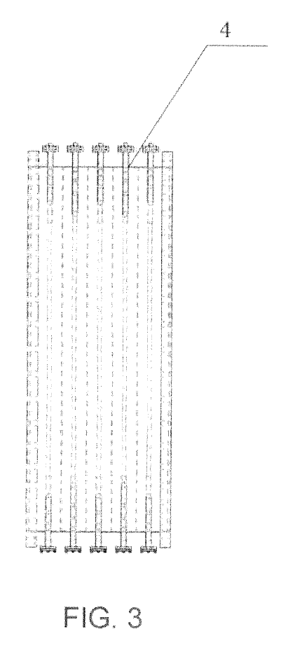

A UV sterilizer for fluid of large flow rate as shown in FIGS. 1, 2 and 3 employs modular design, which comprises at least one UV sterilization module 1 and a mounting part 2 for the same. Each UV sterilization module 1 comprises at least one UV lamp tube 101, and the mounting part 2 comprises a body in the form of a duct for the passage of fluid to be sterilized therethrough. A number of mounting apertures 4 for the UV sterilization module are provided on the wall of the duct, and on one or both end surfaces 201 of the duct are provided a baffle 202 extending from the outer peripheral of the one or both end surfaces 201 towards the center thereof. There is also a port 203 for the passage of fluid to be sterilized therethrough on said one or both end surfaces with the baffle 202. On at least one cross section 204 between the two end surfaces 201 of the mounting part is provided a baffle extending from the outer peripheral of the cross section towards the center thereof, with a port 203 being left for the passage of fluid to be sterilized therethrough. A number of mounting apertures 4 may be provided on the wall of the duct between two cross sections 204. The UV sterilization module 1 is mounted on the wail of the duct of the mounting part 2 via the mounting aperture(s) 4, with the two ends of the sleeve of each UV lamp tube being exposed outside the mounting part 2 and being sealed at the locations where it joints the part 2. Those mounting apertures 4 that are not fitted with a UV sterilization module are blocked with seals. The end surfaces of the mounting part 2 are provided with connecting means 3 for connection with the fluid conduits.

In this embodiment, the mounting part 2 takes the form of a circular duct so as to increase the pressure resistance.

In this embodiment, the baffle 202 on the one or both end surfaces 201 and/or on the at least one cross section 204 of the mounting part may be shaped as inscribing a rectangular, e.g. a square port 203, with each UV lamp tube of the UV sterilization module I being perpendicular to one pair of the edges of the inscribed rectangular, e.g. square, and the edges of said port 203 being within the effective radiation area of the UV sterilization module as predesigned according to the fluid characteristic and the particular requirement for the fluid sterilization. Due to the use of the baffle, the fluid behind the baffle hardly flow, and most of the fluid in the system will flow through the effective radiation area of the UV sterilization module. In this circumstance, since a the UV radiation intensity everywhere in the predesigned effective radiation area is substantially the same the fluid will receive sufficient and substantially uniform amount of UV radiation thus avoiding the fluid flowing out of the sterilization system without being sufficiently sterilized, and improving the sterilization effect.

Due to the use of baffle the port may be sized as close to the edges of the effective radiation area of the UV sterilization module, thus making use of the UV radiation to the maximum content. The two ends of the sleeve of each UV lamp tube are exposed outside the mounting part 2 and are sealed at the locations where it joints the part 2.

In this embodiment, each mounting aperture is fitted with a UV sterilization module and each UV sterilization module comprises only one UV lamp tube. However, in practical use each UV sterilization module may comprise more than one UV lamp tube as required. Each mounting aperture 4 may be blocked with a seal when no UV lamp tube 101 is mounted therein. Thus, each mounting aperture 4 may be individually sealed and it is possible to achieve online maintenance for the sterilization system without affecting the normal operation of the system and the sterilization effect. In this embodiment all the UV lamp tubes are of the same type, and the two ends of the sleeve of each UV lamp tube are exposed outside the mounting part 2 and are sealed at the locations where it joints the part 2. However, in practical use the UV lamp tubes may be of different type as required, and one end of the sleeve may be located inside the mounting part.

Further, all the fluid conduits in the sterilization system comprising the UV sterilizer of the present invention may be connected by means of the mounting part 2. Thus, it is possible to mount at least one UV sterilization module at a suitable location in the system, and to increase or decrease the number of the at least one UV sterilization module as required. It is also possible to mount at least one UV sterilization module at a plurality of locations in the system and to increase or decrease the number of the operating UV sterilization module(s) as required, thereby improving the sterilization effect and economize the cost. The installation and maintenance of the UV sterilizers are facilitated and the system may operate normally while some of the UV sterilizers are being maintained, i.e. on-line maintenance is achieved.

The UV sterilizer for fluid of large flow rate of the present invention employs modular design, which is simple in structure, thus achieving mass-production and being cost-effective.

The UV sterilizer for fluid of large flow rate of the present invention may be widely used in water supply plant, pharmaceutical plant, food plant, drink plant, or other plants or sites where fluid need to be sterilized.

What is claimed is:

1. A UV sterilizer for fluid of large flow rate, which comprises at least one UV sterilization module and a mounting part for the UV sterilization module, each UV sterilization module comprising at least one UV lamp tube, characterized in that said mounting part comprises a body in the form of a duct for the passage of fluid to be sterilized therethrough, with mounting apertures for the UV sterilization module being provided on the wall of the duct, and on one or both end surfaces of the duct there is provided a baffle extending from the outer periphery of said one or both end surfaces towards the center thereof with a port being left on said one or both end surface(s) with the baffle for the passage of fluid to be sterilized therethrough.

2. The UV sterilizer for fluid of large flow rate according to claim 1, characterized in that on at least one cross section between the two end surfaces of the duct are provided a baffle extending from the outer periphery of the cross section towards the center thereof, with a port being left on the cross section with the baffle for the passage of fluid to be sterilized therethrough.

3. The UV sterilizer for fluid of large flow rate according to claim 2, characterized in that said mounting apertures for the UV sterilization module are provided on the wall of the duct between two adjacent cross sections.

4. The UV sterilizer for fluid of large flow rate according to claim 1, characterized in that said port is within the effective radiation area of the UV sterilization module.

5. The UV sterilizer for fluid of large flow rate according to claim 1, characterized in that the cross section of the duct is circular.

6. The UV sterilizer for fluid of large flow rate according to claim 5, characterized in that said port is shaped as a rectangle inscribed in the cross section of the duct.

7. The UV sterilizer for fluid of large flow rate according to claim 5, characterized in that said port is shaped as a square inscribed in the cross section of the duct.

8. The UV sterilizer for fluid of large flow rate according to claim 6, characterized in that said at least one UV lamp tube on each UV sterilization module is perpendicular to one pair of the edges of the inscribed rectangular port.

9. The UV sterilizer for fluid of large flow rate according to claim 7, characterized in that said at least one UV lamp tube on each UV sterilization module is perpendicular to one pair of the edges of the inscribed square port.
